(19) United States
(12) Patent Application Publication
(10) Pub. No.: US 2004/0229078 A1
(43) Pub. Date: Nov. 18, 2004

(54) Plasma resistant article and method of manufacture

(76) Inventor: Takao Maeda, Takefu-shi (JP)

Correspondence Address: BIRCH STEWART KOLASCH & BIRCH, PO BOX 747, FALLS CHURCH, VA, 22040-0747, US

(21) Appl. No.: 10/842,498

(22) Filed: May 11, 2004

(30) Foreign Application Priority Data
May 12, 2003 (JP) 2003-132539

(51) Int. Cl. B32B 15/10

(52) U.S. Cl. 428/650; 428/651

(57) ABSTRACT

A plasma resistant article is composed of an aluminum alloy or anodized aluminum alloy substrate and a thermal sprayed oxide coating which contains yttrium, gadolinium, terbium, dysprosium, holmium or erbium and is endowed with specific characteristics. The article, which has a dense surface and does not require surface polishing, can be used as a component in equipment for manufacturing semiconductors and equipment for manufacturing liquid crystal displays and plasma displays.

### BACKGROUND OF THE INVENTION

1. Field of the Invention

The present invention relates to articles which have a thermal sprayed oxide coating containing yttrium, gadolinium, terbium, dysprosium, holmium or erbium and can be used as, for example, plasma resistant components in semiconductor manufacturing equipment, components in equipment for manufacturing liquid crystal displays and plasma displays, and electrostatic chuck components. The invention also relates to a method of making such articles.

2. Prior Art

Most plasma resistant components for semiconductor manufacturing equipment, components for liquid crystal display and plasma display manufacturing equipment, and electrostatic chuck components which are fabricated by a thermal spraying process are made using alumina. Recently, recognition of the halogen plasma resistance of rare-earth compounds has led also to the development of Y₂O₃ thermal sprayed articles (see, for example, JP-A 2001-164354).

Prior-art thermal sprayed coatings have a surface roughness as coated that is characterized by a centerline average roughness Ra of at least 6 μm and a maximum roughness Rmax of at least 40 μm. This degree of surface unevenness makes it necessary to surface polish the component before it is put to actual use. Such components generally have various curved shapes and therefore cannot be machine polished. Instead, it has been necessary to carry out such polishing by hand, which increases costs and results in contamination of the high-purity coating during the polishing operation. Moreover, polishing dust enters pores in the coating, and cannot be completely removed even by a subsequent ultrasonic cleaning operation.

Also, owing to the presence of such pores, when the workpiece is exposed to halogen gas plasma, for example, the halogen gas enters the pores and penetrates deep into the coating, where it may promote coating deterioration.

Accordingly, there is a need to quantify the pores in a thermal sprayed coating. However, because all the pores cannot be identified by ordinary observation under a scanning electron microscope, such pores have yet to be fully quantified. Another problem is the heat generation that occurs within the microwave range of 400 MHz to several GHz on account of the dielectric loss of the coating substance. When the dielectric loss is large, considerable heat generation occurs, which leads to coating deterioration in addition to that caused by halogen plasma attack during etching processes.

### SUMMARY OF THE INVENTION

The object of the invention is to provide plasma resistant articles which, even after thermal spraying, can be used without requiring a surface polishing operation, which have fewer pores and a smaller dielectric loss, and which are suitable as components in semiconductor manufacturing equipment and equipment for manufacturing liquid crystal displays and plasma displays. Another object of the invention is to provide a method for manufacturing such plasma resistant articles.

I have found that articles which are produced by forming a thermal sprayed oxide coating containing yttrium, gadolinium, terbium, dysprosium, holmium or erbium on an aluminum alloy or anodized aluminum alloy substrate, and in which the thermal sprayed coating has a bond strength with the substrate of at least 20 MPa, a micro Vickers hardness of at least 450 kgf/mm², a surface roughness as coated such that Ra is not more than 5 μm and Rmax is not more than 35 μm, a dielectric strength of at least 25 kV/mm and a dielectric loss (tan δ) at 1 MHz to 1 GHz of not more than 8×10⁻³ possess a dense surface state that obviates the need for a surface polishing operation and can be used as components in semiconductor manufacturing equipment and in equipment for manufacturing liquid crystal displays and plasma displays.

Therefore, the invention provides a plasma resistant article which is composed of an aluminum alloy or anodized aluminum alloy substrate, and a thermal sprayed oxide coating containing yttrium, gadolinium, terbium, dysprosium, holmium or erbium. The thermal sprayed coating has a bond strength with the substrate of at least 20 MPa, a micro Vickers hardness of at least 450 kgf/mm², a surface roughness as coated such that Ra is not more than 5 μm and Rmax is not more than 35 μm, a dielectric strength of at least 25 kV/mm, and a dielectric loss (tan δ) at 1 MHz to 1 GHz of not more than 8×10⁻³.

The invention also provides a method of manufacturing plasma resistant articles, which method involves plasma spraying an oxide powder containing yttrium, gadolinium, terbium, dysprosium, holmium or erbium and having an average particle size of 3 to 20 μm and a relative bulk density of 30 to 50% onto an aluminum alloy or anodized aluminum alloy substrate under atmospheric pressure and at a plasma output of 20 to 150 kW and a powder feed rate corresponding to a deposition rate of 10 to 30 μm/pass so as to form a plasma sprayed coating having a bond strength with the substrate of at least 20 MPa, a micro Vickers hardness of at least 450 kgf/mm², a surface roughness as coated such that Ra is not more than 5 μm and Rmax is not more than 35 μm, a dielectric strength of at least 25 kV/mm, and a dielectric loss (tan δ) at 1 MHz to 1 GHz of not more than 8×10⁻³.

### DETAILED DESCRIPTION OF THE INVENTION

The plasma resistant article of the invention is composed of a substrate made of an aluminum alloy or an aluminum alloy that has been anodized so as to form thereon an anodic film, on which substrate has been formed a thermal sprayed oxide coating containing one or more element selected from the group consisting of yttrium, gadolinium, terbium, dysprosium, holmium and erbium.

It is desirable for the aluminum alloy to have an aluminum content of at least 90 wt %, and preferably at least 95 wt %, and for the aluminum therein to be alloyed with one or more element such as manganese, copper, silicon, magnesium, chromium and zirconium.

The thermal sprayed coating may be composed solely of an oxide of one or more element selected from among yttrium, gadolinium, terbium, dysprosium, holmium and erbium, or may be arrived at by mixing or combining with this oxide the oxides of aluminum, magnesium, silicon, zirconium and titanium in an amount, based on the overall coating, of not more than 60 wt %, and preferably not more than 50 wt %.

The thermal sprayed coating has a thickness which is suitably selected according to such considerations as the intended purpose and manner of use, although a thickness within a range of 50 to 500 μm, and especially 100 to 400 μm, is preferred.

In the practice of the invention, the thermal sprayed coating has a bond strength with the substrate of at least 20 MPa, and preferably at least 25 MPa. At a bond strength of less than 20 MPa, delamination occurs during CO₂ blast cleaning of the article following use.

The bond strength has no particular upper limit, although the strength is generally up to about 60 MPa, and preferably up to about 50 MPa.

The thermal sprayed coating has a micro Vickers hardness of at least 450 kgf/mm². The micro Vickers hardness is related to plasma erodibility. At a micro Vickers hardness of less than 450 kgf/mm², the coating has a poor plasma resistance. There is no particular upper limit to the micro Vickers hardness, although this value is generally not more than 2,000 kgf/mm².

The surface roughness as coated is characterized by a centerline average roughness Ra of not more than 5 μm, preferably not more than 4.8 μm, and a maximum roughness Rmax of not more than 35 μm, preferably not more than 32 μm. At Ra greater than 5 μm or Rmax greater than 35 μm, the surface is too rough and must therefore be polished to finish it to a smooth surface. Ra and Rmax are not subject to any lower limits and should be as low as possible.

The dielectric strength is at least 25 kV/mm. The dielectric strength is related to the porosity of the thermal sprayed coating. At a dielectric strength of less than 25 kV/mm, the coating has many pores. To achieve a denser coating, the dielectric strength must be at least 25 kV/mm.

The thermal sprayed coating has a dielectric loss (tan δ) at 1 MHz to 1 GHz of not more than 8×10⁻³, and preferably not more than 6×10⁻³. At a dielectric loss of more than 8×10⁻³, the plasma resistant article reaches too high a temperature during use due to an induction heating phenomenon. The dielectric loss should be as low as possible.

Thermal spraying techniques for forming thermal sprayed coatings include flame spraying, high-velocity flame spraying (HVOF), detonation flame spraying, plasma spraying, water-stabilized plasma spraying, induction (RF) plasma spraying, electromagnetically accelerated plasma spraying, cold spraying and laser spraying. In the practice of the invention, the spraying method is not subject to any particular limitation, although plasma spraying is preferred because it has a high spraying output.

Thermal spraying may be carried out in various atmospheres. For example, there are atmospheric pressure spraying processes, and there are also decompression spraying processes and vacuum spraying processes which involve carrying out thermal spraying in a decompression chamber or a vacuum chamber. To form a denser coating, it is desirable that the number of internal pores be reduced, and so there are times where decompression spraying is used. However, decompression spraying or vacuum spraying requires the use of a decompression or vacuum chamber, which space or time restriction on the thermal spraying process. For this reason, the present invention makes use of an atmospheric pressure spraying process which can be carried out without a special pressure vessel.

The plasma spray system consists primarily of a plasma gun, a power supply, a powder feeder and a gas controller. The plasma output is determined by the power that is supplied and the feed rates of, for example, argon gas, nitrogen gas, hydrogen gas and helium gas. The powder feed rate is controlled by the powder feeder.

Plasma spraying is a process that involves generating plasma with a plasma gun, injecting powder into the plasma so as to melt the powder, and immediately impacting the melted powder on a substrate to form a film. Film formation thus requires that the spraying powder be fully melted and travel at a high velocity. For the plasma spraying powder to melt in a sufficiently short time, it is desirable that it have as small a particle size as possible. However, when the particle size is small, the spraying powder has a reduced fluidity and is difficult to feed. In addition, light particles having an average particle size of less than 3 μm are blown aside instead of entering the plasma flame, so that a sprayed coating does not form.

In the practice of the invention, to manufacture plasma sprayed articles having a smoother, denser surface under the spraying conditions described above, it is important to use a denser plasma spraying material of a small particle size. Accordingly, the spraying powder must have an average particle size of 3 μm to 20 μm and a relative bulk density of 30 to 50%. The average particle size can be determined as, for example, the weight mean diameter (or median diameter) by a technique such as laser light diffraction.

The relative bulk density is a ratio of the bulk density with respect to the true density. At a relative bulk density lower than 30%, the sprayed coating lacks the required density. On the other hand, at a relative bulk density higher than 50%, the powder packs too well and thus has a diminished fluidity.

When plasma spraying is carried out using the powder described above, at a low plasma output during spraying, the plasma is unable to fully melt the powder, resulting in a larger number of pores in the coating. On the other hand, a high plasma output during spraying causes excessive melting of the powder, lowering its viscosity and resulting in increased spatter by the powder when it impacts the substrate, which is an additional cause of pore formation. Also, the plasma spraying time may be shortened by increasing the spraying powder feed rate at a high plasma output, although this increases the coating thickness deposited in a single pass, ultimately leaving pores in the resultant coating. It is therefore necessary to adjust the plasma output and powder feed rate during plasma spraying. Specifically, in the inventive process, the coating is formed by plasma spraying at a plasma output of 20 to 150 kW and at a powder feed rate adjusted so as to give a film-forming rate of 10 to 30 μm/pass when plasma spraying is carried out by moving a plasma-gun and/or the substrate. In this way, the sprayed coating can be imparted with a surface roughness such that Ra is not more than 5 μm and Rmax is not more than 35 μm.

The surface of the substrate may be roughened by sandblasting or the temperature of the substrate may be heated to 100 to 300° C. just before thermal spraying so as to increase the bond strength and more reliably set it to a value of at least 20 MPa.

The micro Vickers hardness can be determined using a digital microhardness tester manufactured by Matsuzawa Co., Ltd. In this method, the test specimen is surface polished and the probe load is set to 300 g. The size of the surface indentation is then measured under a microscope, based on which the micro Vickers hardness Hv is computed.

The porosity of a thermal sprayed coating is generally measured by examining the surface of the coating under a scanning electron microscope. However, in this disclosure intended for better quantitative description, the porosity is instead measured based on the electrical insulating properties of the coating; coatings with a higher dielectric strength are regarded as having a lower porosity. It is thus critical for the thermal sprayed coating in the invention to have a dielectric strength of at least 25 kV/mm. For example, prior-art thermal sprayed Y₂O₃ coatings have a dielectric strength of 10 to 20 kV/mm, whereas thermal sprayed Y₂O₃ coatings in the present invention have a dielectric strength of at least 25 kV/mm. The latter coatings are thus presumed to have fewer small pores.

Measurement of the dielectric breakdown voltage can be carried out in accordance with JIS C2110 using, for example, a test plate obtained by plasma spraying an oxide onto a metal plate. The sprayed coating on the test plate has a thickness of preferably about 100 to 500 μm.

For example, one surface of a 100×100×5(t) mm aluminum plate is blasted then plasma sprayed with the above-mentioned oxide such as Y₂O₃ so as to form a sprayed coating having a thickness of about 200 μm. The coated plate is then placed between electrodes as described in JIS C2110, the voltage is ramped up at a rate of 200 V/s, and the voltage at which dielectric breakdown occurs is measured. The measured voltage is then divided by the thickness of the coating to give the dielectric strength.

The dielectric loss of the sprayed coating is the value at a frequency of 1 MHz to 1 GHz. To measure the dielectric loss, a sprayed coating is formed on an aluminum alloy disc of 50 mm diameter and 5 mm thickness or 12 mm diameter and 2.5 mm thickness, then polishing the coating down to a thickness of about 200 μm. A counter electrode is formed by applying silver paste onto the sprayed coating over an area having a diameter of 40 mm on the 50 mm diameter disc, or over an area having a diameter of 10 mm on the 12 mm diameter disc.

Measurement is carried out using an HP4194A analyzer and a 16451B electrode (both manufactured by Agilent Technologies). In the radio frequency range, measurement is carried out using a combination of an E4991A analyzer and a 16453A electrode (both manufactured by Agilent Technologies).

### EXAMPLES

Examples of the invention and comparative examples are given below by way of illustration and not by way of limitation.

### EXAMPLES 1 TO 6

In each example, using a spraying powder composed of an oxide of yttrium, gadolinium, terbium, dysprosium, holmium or erbium and having an average particle size of 10 to 20 μm and a relative bulk density of 30 to 50%, plasma spraying was carried out at a plasma output of 35 kW, an argon gas feed rate of 40 L/min, a hydrogen gas feed rate of 7 L/min and a powder feed rate adjusted so as to give a coating thickness of 15 μm/pass, thereby forming a 200 to 300 μm thick plasma sprayed coating on a 100×100×5(t) mm aluminum plate.

The sprayed coating was subjected to measurement of the dielectric breakdown voltage without being sealed. Measurement was carried out in accordance with JIS C2110. Voltage ramping was carried out at a rate of 200 V/s, and the voltage at the time of dielectric breakdown was divided by the coating thickness to give the dielectric strength.

To determine the micro Vickers hardness, the above-described substrate on which a plasma sprayed coating had been formed was cut to dimensions of 20×20×5(t) mm, the surface was polished, and the micro Vickers hardness was measured by the method described above.

The dielectric loss was determined by forming a 200 to 300 μm plasma sprayed coating on an aluminum alloy disc of 50 mm diameter and 5 mm thickness or 12 mm diameter and 2.5 mm thickness, then polishing the coating down to a thickness of about 200 μm, ultrasonic washing, and drying. Next, silver paste was used to form a 40 mm diameter electrode on the 50 mm diameter coated disc, and a 10 mm diameter electrode on the 12 mm diameter coated disc.

The dielectric loss at 1 MHz was measured with a 16451B test electrode and a 4194A analyzer, and the dielectric loss at 1 GHz was measured with a 16453A test electrode and an E4991A analyzer.

A 25 mm diameter, 10 mm thick mm disk having formed thereon a 200 to 300 μm sprayed coating and an aluminum disc of the same shape that had been blasted on one side were laminated together using an epoxy adhesive, and the bond strength was measured using a tension testing machine.

Each test specimen was sandblasted and heated to a plate temperature of 100 to 300° C. prior to plasma spraying.

### Comparative Example 1

Plasma sprayed coated samples were produced by the same method as in Example 1 using a prior-art Y₂O₃ spraying powder, at a plasma output of 40 kW, an argon gas flow rate of 45 L/min and a hydrogen gas flow rate of 12 L/min, and at a powder feed rate adjusted to give a deposition rate of 25 μm/pass.

TABLE 1

| | | | Micro | Surface | | | | |
|---|---|---|---|---|---|---|---|---|
| | Thermal | Bond | Vickers | roughness | | Dielectric | Dielectric | |
| | spraying | strength | hardness | Ra | Rmax | strength | loss, tanδ | |
| | material | (MPa) | (kgf/mm²) | (μm) | (μm) | (kV/mm) | 1 MHz | 1 GHz |
| Example 1 | Y₂O₃ | 32 | 520 | 3.2 | 28 | 31 | 0.001 | 0.0006 |
| Example 2 | Gd₂O₃ | 28 | 505 | 3.4 | 27 | 31 | 0.004 | 0.0008 |
| Example 3 | Tb₂O₃ | 27 | 486 | 3.8 | 25 | 28 | 0.003 | 0.0009 |
| Example 4 | Dy₂O₃ | 31 | 493 | 3.5 | 29 | 27 | 0.006 | 0.0008 |
| Example 5 | Ho₂O₃ | 26 | 461 | 3.6 | 25 | 28 | 0.007 | 0.0007 |
| Example 6 | Er₂O₃ | 25 | 497 | 3.5 | 32 | 29 | 0.002 | 0.0005 |
| Comparative | Y₂O₃ | 15 | 386 | 5.6 | 52 | 14 | 0.002 | 0.0007 |
| Example 1 | | | | | | | | |

As is described above and demonstrated in the foregoing examples, the plasma resistant articles of the invention have a dense surface and require no surface polishing, which qualities make them suitable for use as plasma resistant components in semiconductor manufacturing equipment and in liquid crystal display and plasma display manufacturing equipment. Moreover, the manufacturing process of the invention enables the reliable manufacture of such plasma resistant articles.

Japanese Patent Application No. 2003-132539 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A plasma resistant article comprising
an aluminum alloy or anodized aluminum alloy substrate, and
a thermal sprayed oxide coating thereon containing yttrium, gadolinium, terbium, dysprosium, holmium or erbium; wherein the thermal sprayed coating has a bond strength with the substrate of at least 20 MPa, a micro Vickers hardness of at least 450 kgf/mm², a surface roughness as coated such that Ra is not more than 5 μm and Rmax is not more than 35 μm, a dielectric strength of at least 25 kV/mm, and a dielectric loss (tan δ) at 1 MHz to 1 GHz of not more than 8×10⁻³.

2. The plasma resistant article of claim 1 which is adapted for use in semiconductor manufacturing equipment.

3. The plasma resistant article of claim 1 which is adapted for use in liquid crystal display or plasma display manufacturing equipment.

4. A method of manufacturing a plasma resistant article, comprising the step of plasma spraying an oxide powder containing yttrium, gadolinium, terbium, dysprosium, holmium or erbium and having an average particle size of 3 to 20 μm and a relative bulk density of 30 to 50% onto an aluminum alloy or anodized aluminum alloy substrate under atmospheric pressure and at a plasma output of 20 to 150 kW and a powder feed rate corresponding to a deposition rate of 10 to 30 μm/pass so as to form a plasma sprayed coating having a bond strength with the substrate of at least 20 MPa, a micro Vickers hardness of at least 450 kgf/mm², a surface roughness as coated such that Ra is not more than 5 μm and Rmax is not more than 35 μm, a dielectric strength of at least 25 kV/mm, and a dielectric loss (tan δ) at 1 MHz to 1 GHz of not more than 8×10⁻³.

5. The method of claim 4, further comprising heating the substrate to 100 to 300° C. prior to the plasma spraying step.
